(19) United States
(12) Patent Application Publication
(10) Pub. No.: US 2014/0065853 A1
(43) Pub. Date: Mar. 6, 2014

(54) CONNECTING STRUCTURE FOR FLEXIBLE PRINTED WIRING BOARDS

(71) Applicant: Kazuya Murakami, Osaka (JP)

(72) Inventor: Kazuya Murakami, Osaka (JP)

(73) Assignee: SHARP KABUSHIKI KAISHA, Osaka (JP)

(21) Appl. No.: 14/117,849

(22) PCT Filed: May 16, 2012
(86) PCT No.: PCT/JP2012/062502

§ 371 Date: Nov. 14, 2013

(30) Foreign Application Priority Data
May 23, 2011 (JP) 2011-114434

(51) Int. Cl. H01R 12/77

(52) U.S. Cl. CPC H01R 12/77
USPC 439/77

(57) ABSTRACT

A first flexible printed wiring board (10) has a first wiring line (14) and includes a first opening (12) and second opening (13) that are positioned at a prescribed distance from each other. A portion of a second flexible printed wiring board (20) is inserted into the first opening (12) and second opening (13). The second flexible printed wiring board (20) has a second wiring line (22) on a narrow-width section (26), which is located at a tip part in an insertion direction (30) and has a smaller width than the first opening (12) and second opening (13) in a width direction (31) that is perpendicular to the insertion direction (30) towards the first flexible printed wiring board (10). The second flexible printed wiring board (20) contains a positioning section (24) that connects to the narrow-width section (26) and that has a width greater than either the first opening (12) or the second opening (13) in the width direction (31). In other words, the first wiring line (14) and the second wiring line (22) are connected when the first opening (12) or the second opening (13) is coupled to the positioning section (24) to lock the first flexible printed wiring board (10) and the second flexible printed wiring board (20) together.

### TECHNICAL FIELD

The present invention relates to a connecting structure for flexible printed wiring boards, and particularly relates to a connecting structure in which flexible printed wiring boards are connected to each other.

### BACKGROUND ART

Japanese Utility Model Laid-Open Publication No. H4-116176 (Patent Document 1) is a related art document that discloses a connecting structure for flexible printed wiring boards. The connecting structure for flexible printed wiring boards disclosed in Patent Document 1 includes a joining part between the flexible printed wiring boards and a hard substrate. The hard substrate has: a connecting part that electrically connects the hard substrate and the flexible printed wiring boards; notches formed on the hard substrate that have a length equal to the width of the flexible printed wiring boards; and notches formed on the flexible printed wiring boards. The notches on the hard substrate and notches on the flexible printed wiring boards are combined together.

### RELATED ART DOCUMENT

### Patent Document

Patent Document 1: Japanese Utility Model Laid-Open Publication No. H4-116176

### SUMMARY OF THE INVENTION

### Problems to be Solved by the Invention

If joining the notches formed on the hard substrate with the notches formed on the flexible printed wiring boards in order to lock the hard substrate and flexible printed wiring boards together, the connection between the notches is susceptible to coming undone when stress is applied to the flexible printed wiring boards. Therefore, it is not possible to stably prevent stress exerted on the connecting parts of the hard substrate and flexible printed wiring boards.

The present invention was made in view of the above-mentioned problem and aims at providing a connecting structure for flexible printed wiring boards in which stress exerted on connecting parts can be suppressed, while positioning the flexible printed wiring boards at a prescribed location.

### Means for Solving the Problems

A connecting structure for flexible printed wiring boards, configured such that a first wiring line on a first flexible printed wiring board electrically connects to a second wiring line on a second flexible printed wiring board, wherein the first flexible printed wiring board includes: the first wiring line on one main surface thereof; and an elongated first opening and an elongated second opening that are positioned at a prescribed distance from each other, the second flexible printed wiring board having a portion to be inserted into the first opening and the second opening, wherein the second flexible printed wiring board includes: the second wiring line on one main surface of a narrow-width section, the narrow-width section being located at a tip area in an insertion direction and having a smaller width than the first opening and the second opening in a width direction, the width direction being perpendicular to the insertion direction towards the first flexible printed wiring board; and a positioning section that is connected to the narrow-width section and that has a greater width than either the first opening or the second opening in the width direction, wherein the second flexible printed wiring board is on a side of the other main surface of the first flexible printed wiring board between the first opening and the second opening when the narrow-width section is inserted into the first opening and the second opening, and, the second flexible printed wiring board is on a side of the one main surface of the first flexible printed wiring board at a side of the first opening that is opposite to the second opening and a side of the second opening that is opposite to the first opening, and wherein the first wiring line and the second wiring line are connected when the first opening or the second opening is coupled to the positioning section to lock the first flexible printed wiring board and the second flexible printed wiring board together.

In one aspect of the present invention, the insertion direction and the extending direction of the first opening intersect each other at an acute angle.

In one aspect of the present invention, the narrow-width section of the second flexible printed wiring board has a tapered shape that becomes wider the further the narrow-width is from the tip.

In one aspect of the present invention, the first opening is wider than the second opening in the width direction. The narrow-width section has a uniform width that is less than the width of the second opening. The positioning part is narrower than the first opening in the width direction and wider than the second opening in the width direction.

### Effects of the Invention

According to the present invention, stress being exerted on connecting parts can be suppressed, while positioning flexible printed wiring boards at a prescribed location.

### BRIEF DESCRIPTION OF THE DRAWINGS

FIG. 1 is a partial plan view showing a first flexible printed wiring board and a second flexible printed wiring board, both of which form a connecting structure for flexible printed wiring boards according to Embodiment 1 of the present invention.

FIG. 2 is a plan view showing a state in which the first flexible printed wiring board and second flexible printed wiring board have been locked together in Embodiment 1.

FIG. 3 is a side view as seen from the direction of the arrow III in FIG. 2.

FIG. 4 is a plan view showing a state in which a first wiring line of the first flexible printed wiring board and a second wiring line of the second flexible printed wiring board have been connected by solder.

FIG. 5 is a side view as seen from the direction of the arrow V in FIG. 4.

FIG. 6 is a partial plan view showing a first flexible printed wiring board and a second flexible printed wiring board, both of which form a connecting structure for flexible printed wiring boards according to Embodiment 2 of the present invention.

FIG. 7 is a plan view showing a state in which a tip of the second flexible printed wiring board has been inserted into a first opening of the first flexible printed wiring board in Embodiment 2.

FIG. 8 is a plan view showing a state in which the first flexible printed wiring board and second flexible printed wiring board have been locked together in Embodiment 2.

FIG. 9 is a partial plan view showing a first flexible printed wiring board and a second flexible printed wiring board, both of which form a connecting structure for flexible printed wiring boards according to Embodiment 3 of the present invention.

FIG. 10 is a plan view showing a state in which the first flexible printed wiring board and second flexible printed wiring board have been locked together in Embodiment 3.

### DETAILED DESCRIPTION OF EMBODIMENTS

A connecting structure for flexible printed wiring boards according to Embodiment 1 of the present invention will be explained below. In the descriptions for embodiments below, the identical or corresponding portions in the respective drawings are given the same reference characters, and descriptions thereof will not be repeated. In the explanations of the embodiments, the expressions up, down, left, and right are used for convenience of explanation, but these expressions are based on the figures that are shown and do not limit the configurations of the present invention.

### Embodiment 1

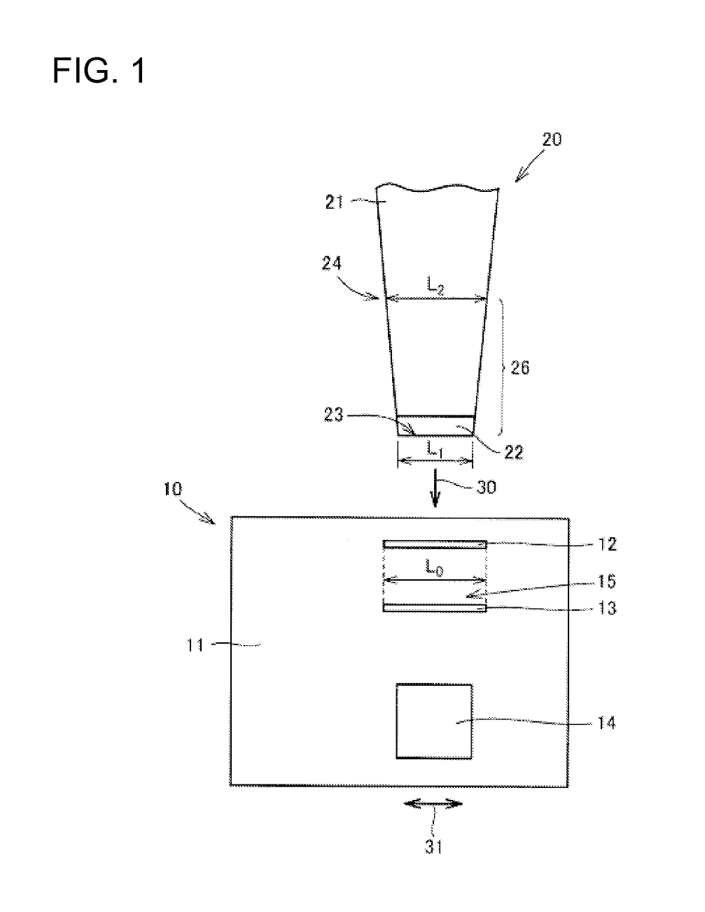

FIG. 1 is a partial plan view showing a first flexible printed wiring board and a second flexible printed wiring board, both of which form a connecting structure for flexible printed wiring boards according to Embodiment 1 of the present invention.

As shown in FIG. 1, in the connecting structure for flexible printed wiring boards in Embodiment 1 of the present invention, a first wiring line 14 of a first flexible printed wiring board 10 and a second wiring line 22 of a second flexible printed wiring board 20 will be electrically connected.

The flexible printed wiring board 10 has the first wiring line 14 on one main surface, and includes a first opening 12 and second opening 13 that are elongated and that are positioned at a prescribed distance from each other. A portion of the second flexible printed wiring board 20 is inserted into the first opening 12 and second opening 13.

This portion of the second flexible printed wiring board 20 is inserted into the first flexible printed wiring board 10 in the direction shown by an arrow 30 in the drawing. The width direction that is perpendicular to this insertion direction is shown by an arrow 31 in the drawing.

In the first flexible printed wiring board 10, the first wiring line 14 is formed on the one main surface of a base material 11. In FIG. 1, only a soldered portion of the first wiring line 14 is shown.

The rectangular first opening 12 and second opening 13, which extend in the width direction, are formed substantially parallel to each other on the base material 11. The width in the width direction of the first opening 12 and second opening 13 is L₀. The gap between the first opening 12 and second opening 13 in the insertion direction acts as a folding part 15, which is explained later.

The second flexible printed wiring board 20 has the second wiring line 22 on one main surface on a narrow-width section 26, which is located at the tip part in the insertion direction and has a width that is less than the width L₀ of the first opening 12 and second opening 13 in the width direction. The second flexible printed wiring board 20 contains a positioning section 24 that connects to the narrow-width section 26 and that has a width L₂ greater than the width L₀ of the first opening 12 and second opening 13 in the width direction.

In the present embodiment, the narrow-width section 26 of the second flexible printed wiring board 20 has a tapered shape that becomes wider the further the narrow-width section 26 is from a tip 23, which has a width L₁. The width L₂ of the positioning section 24 is slightly greater than the width L₀.

In the second flexible printed wiring board 20, the second wiring line 22 is formed on the one main surface of a base material 21. In FIG. 1, only a soldered portion of the second wiring line 22 is shown. The soldered portion of the second wiring line 22 is formed in the vicinity of the tip 23 of the second flexible printed wiring board 20.

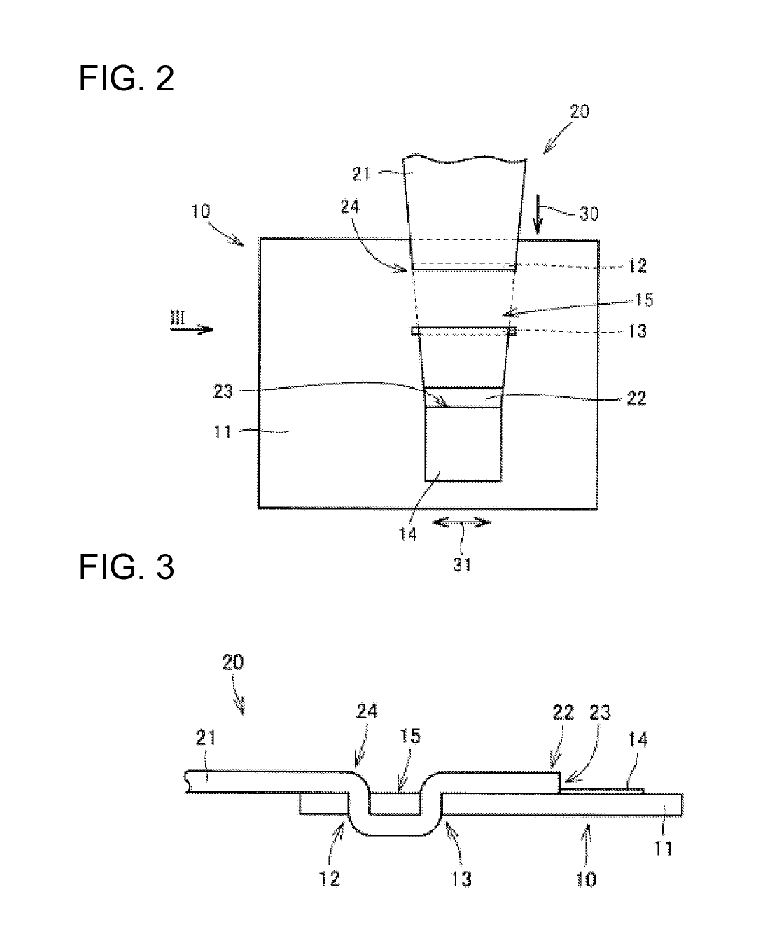

FIG. 2 is a plan view showing a state in which the first flexible printed wiring board and second flexible printed wiring board have been locked together in the present embodiment. FIG. 3 is a side view as seen from the direction of an arrow III in FIG. 2.

As shown in FIGS. 2 and 3, when the narrow-width section 26 of the second flexible printed wiring board 20 is inserted into the first opening 12 and second opening 13 of the first flexible printed wiring board 10, the second flexible printed wiring board 20 is positioned on the other main surface of the first flexible printed wiring board 10 between the first opening 12 and second opening 13. The second flexible printed wiring board 20 is also positioned on the one main surface of the first flexible printed wiring board 10 opposite to the side of the first opening 12 near the second opening 13 and opposite to the side of the second opening 13 near the first opening 12.

In other words, the second flexible printed wiring board 20 is folded at the folding part 15 located between the first opening 12 and second opening 13.

The width L₂ of the positioning section 24 of the second flexible printed wiring board 20 is slightly greater than the width L₀ of the first opening 12, resulting in the first opening 12 and positioning section 24 being joined together when the narrow-width section 26 goes through the first opening 12.

In this state, the soldering portion of the first wiring line 14 of the first flexible printed wiring board 10 and the soldering portion of the second wiring line 22 of the second flexible printed wiring board 20 are positioned adjacent to each other. In this manner, the second flexible printed wiring board 20 is positioned at a prescribed location with respect to the first flexible printed wiring board 10.

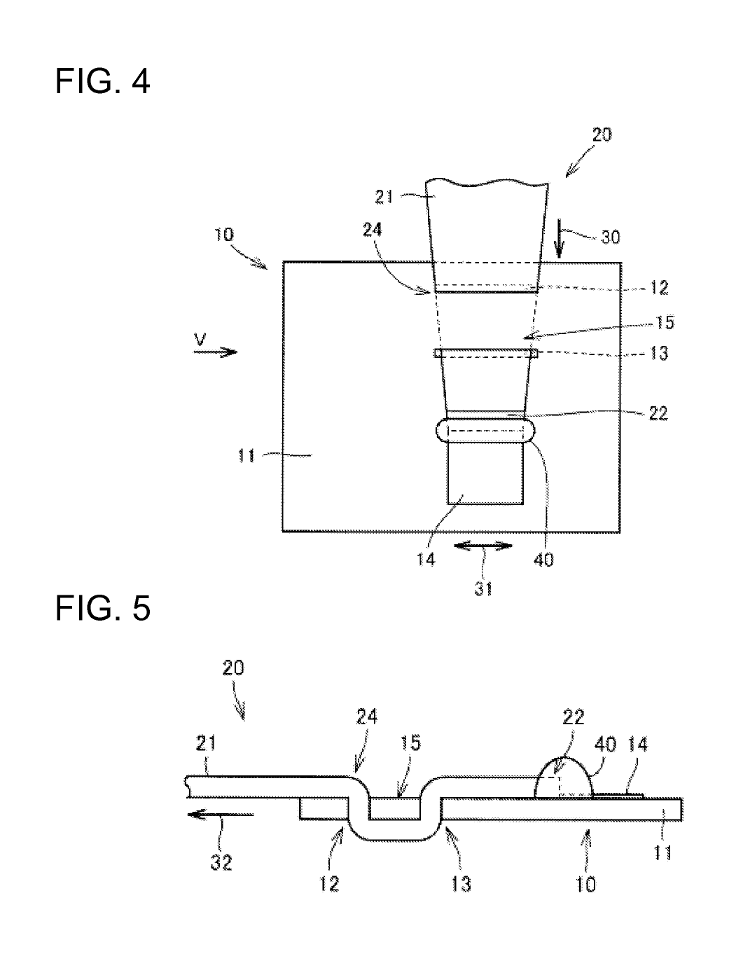

FIG. 4 is a plan view showing a state in which the first wiring line of the first flexible printed wiring board and second wiring line of the second flexible printed wiring board have been connected together with solder. FIG. 5 is a side view as seen from the direction of an arrow V in FIG. 4.

As shown in FIGS. 4 and 5, solder 40 is applied so as to cover both the soldering portion of the first wiring line 14 of the first flexible printed wiring board 10 and the soldering portion of the second wiring line 22 of the second flexible printed wiring board 20. The solder 40 electrically connects the first flexible printed wiring board 10 and the second flexible printed wiring board 20.

In other words, the first wiring line 14 and the second wiring line 22 are connected when the first opening 12 of the first flexible printed wiring board 10 and the positioning section 24 of the second flexible printed wiring board 20 are joined in order to lock the first flexible printed wiring board 10 and the second flexible printed wiring board 20 together.

As described above, electrically connecting the first flexible printed wiring board 10 and the second flexible printed wiring board 20 together joins the first opening 12 of the first flexible printed wiring board 10 and the positioning section 24 of the second flexible printed wiring board 20, and thus, it is possible to suppress stress being exerted on the connecting part formed by the solder 40 when stress is applied in the width direction shown by the arrow 31 to the base material 21 of the second flexible printed wiring board 20.

When stress is applied in the direction shown by the arrow 32 in FIG. 5 to the base material 21 of the second flexible printed wiring board 20, the second flexible printed wiring board 20 will fold at the folding part 15 of the first flexible printed wiring board 10, resulting in being able to suppress stress exerted on the connecting part formed by the solder 40.

In other words, it is possible to suppress stress from being exerted on the connection part formed by the solder 40, while positioning the second flexible printed wiring board 20 at a prescribed location with respect to the first flexible printed wiring board 10. As a result, the durability of the connection part can be improved, while stably connecting the first flexible printed wiring board 10 and the second flexible printed wiring board 20.

In the present embodiment, the first opening 12 and second opening 13 are parallel to each other and have the same width, but without being limited thereto, the extending direction of the first opening 12 and the extending direction of the second opening 13 may intersect and the first opening 12 and second opening 13 may have mutually different widths.

A connecting structure for flexible printed wiring boards according to Embodiment 2 of the present invention will be explained below. In the connecting structure for flexible printed wiring boards according to the present embodiment, only a location of a first opening and second opening of a first flexible printed circuit board differs from the connecting structure for flexible printed wiring boards in Embodiment 1, and thus, explanations for other elements will not be repeated.

### Embodiment 2

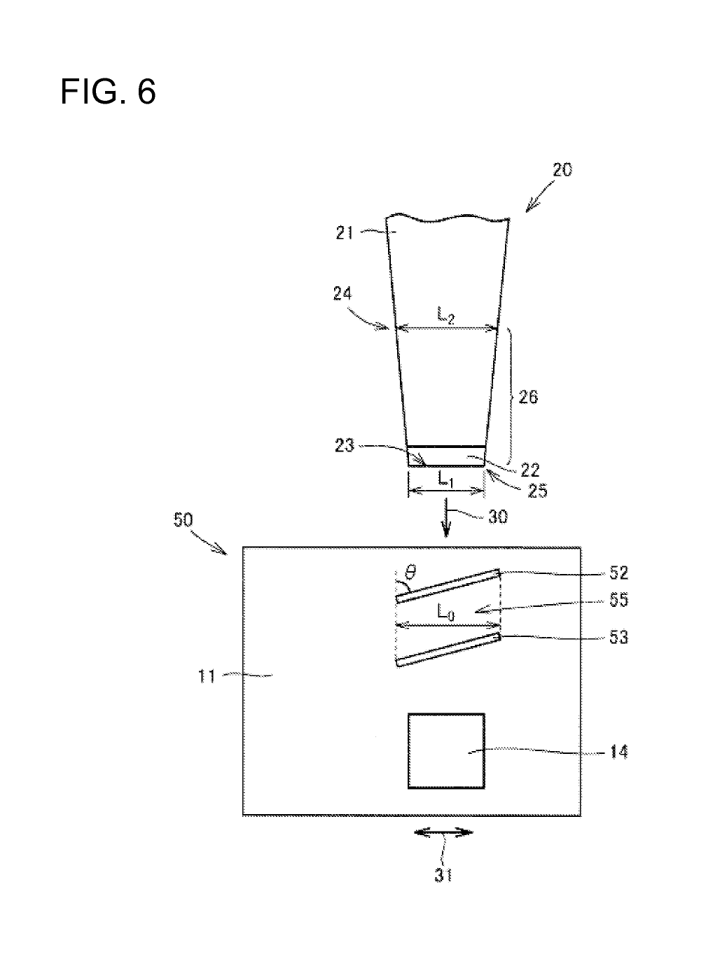

FIG. 6 is a partial plan view showing a first flexible printed wiring board and a second flexible printed wiring board, both of which form a connecting structure for flexible printed wiring boards according to Embodiment 2 of the present invention.

As shown in FIG. 6, in the connecting structure for flexible printed wiring boards in Embodiment 2 of the present invention, a first wiring line 14 of a first flexible printed wiring board 50 and a second wiring line 22 of a second flexible printed wiring board 20 will be electrically connected.

The flexible printed wiring board 50 has the first wiring line 14 on one main surface, and includes a first opening 52 and second opening 53 that extend at a prescribed distance from each other. A portion of the second flexible printed wiring board 20 is inserted into the first opening 52 and second opening 53.

In the first flexible printed wiring board 50, the first wiring line 14 is formed on the one main surface of a base material 11. In FIG. 6, only a soldered portion of the first wiring line 14 is shown.

The rectangular first opening 52 and second opening 53 are formed substantially parallel to each other and extend in a direction that intersects with the insertion direction at an angle θ. The width in the width direction of the first opening 52 and second opening 53 is L₀. The gap between the first opening 52 and second opening 53 in the insertion direction acts as a folding part 55.

In the present embodiment, the angle θ is an acute angle. In other words, the insertion direction and the extending direction of the first opening 52 intersect at an acute angle.

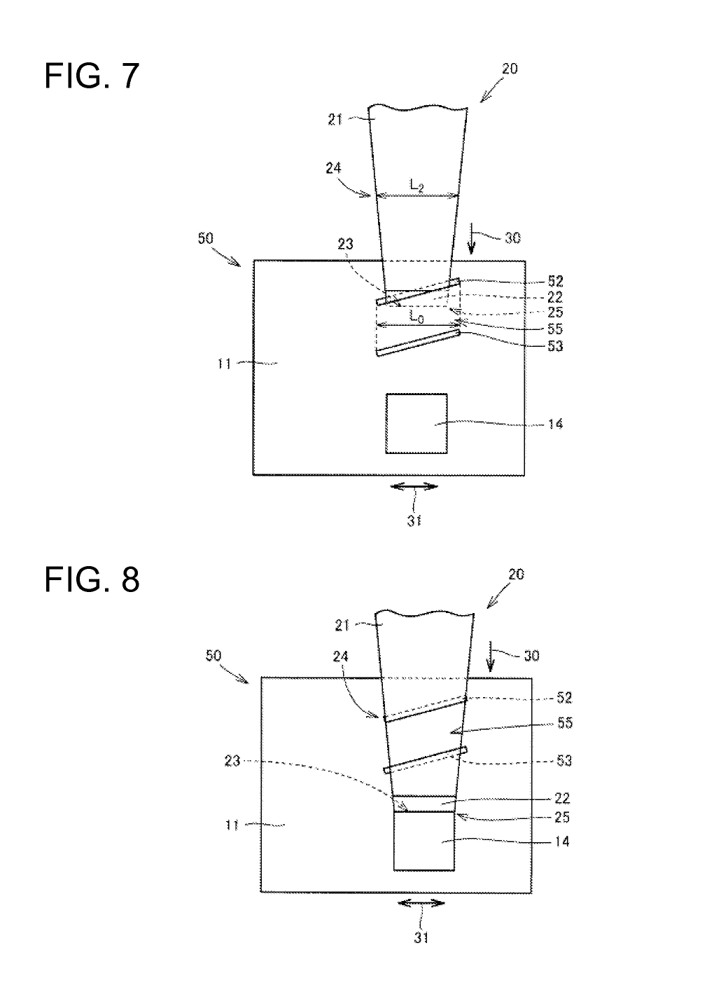

FIG. 7 is a plan view showing a state in which a tip of the second flexible printed wiring board has been inserted into the first opening of the first flexible printed wiring board in Embodiment 2.

As shown in FIG. 7, the first opening 52 is slanted towards the insertion direction, and thus, a tip corner section 25 initially passes through the first opening 52 when a tip 23 of the second flexible printed wiring board 20 is inserted into the first opening 52 of the first flexible printed wiring board 50.

In this way, a narrow-width section 26 of the second flexible printed wiring board 20 can be more easily inserted into the first opening 52 of the first flexible printed wiring 50 than if the entire tip 23 of the second flexible printed wiring board 20 were to be simultaneously inserted into the first opening 52 of the first flexible printed wiring board 50.

In a similar manner, the second opening 53 is slanted towards the insertion direction, and thus, the tip corner section 25 initially passes through the second opening 53 when the tip 23 of the second flexible printed wiring board 20 is inserted into the second opening 53 of the first flexible printed wiring board 50.

In this way, a narrow-width section 26 of the second flexible printed wiring board 20 can be more easily inserted into the second opening 53 of the first flexible printed wiring 50 than if the entire tip 23 of the second flexible printed wiring board 20 were to be simultaneously inserted into the second opening of the first flexible printed wiring board 50.

FIG. 8 is a plan view showing a state in which the first flexible printed wiring board and second flexible printed wiring board have been locked together in the present embodiment.

As shown in FIG. 8, when the narrow-width section 26 of the second flexible printed wiring board 20 is inserted into the first opening 52 and second opening 53 of the first flexible printed wiring board 50, the second flexible printed wiring board 20 is positioned on the other main surface of the first flexible printed wiring board 50 between the first opening 52 and second opening 53. The second flexible printed wiring board 20 is also positioned on the one main surface of the first flexible printed wiring board 50 opposite to the side of the first opening 52 near the second opening 53 and opposite to the side of the second opening 53 near the first opening 52.

In other words, the second flexible printed wiring board 20 is folded at the folding part 55 located between the first opening 52 and second opening 53.

A width L₂ of a positioning section 24 of the second flexible printed wiring board 20 is slightly greater than the a width L₀in the width direction of the first opening 52, resulting in the first opening 52 and positioning section 24 being joined together when the narrow-width section 26 goes through the first opening 52.

In this state, the soldering portion of the first wiring line 14 of the first flexible printed wiring board 50 and the soldering portion of the second wiring line 22 of the second flexible printed wiring board 20 are positioned adjacent to each other. As such, the second flexible printed wiring board 20 is positioned at a prescribed location with respect to the first flexible printed wiring board 50.

Solder is applied so as to cover both the soldering portion of the first wiring line 14 of the first flexible printed wiring board 50 and the soldering portion of the second wiring line 22 of the second flexible printed wiring board 20. The solder electrically connects the first flexible printed wiring board 50 and the second flexible printed wiring board 20.

In other words, the first wiring line 14 and the second wiring line 22 are connected when the first opening 52 of the first flexible printed wiring board 50 and the positioning section 24 of the second flexible printed wiring board 20 are joined in order to lock the first flexible printed wiring board 50 and the second flexible printed wiring board 20 together.

As described above, electrically connecting the first flexible printed wiring board 50 and the second flexible printed wiring board 20 together joins the first opening 52 of the first flexible printed wiring board 50 and the positioning section 24 of the second flexible printed wiring board 20, and thus, it is possible to suppress stress being exerted on the connecting part formed by the solder when stress is applied in the width direction shown by an arrow 31 to a base material 21 of the second flexible printed wiring board 20.

When stress that is the opposite direction to the insertion direction is applied to the base material 21 of the second flexible printed wiring board 20, the second flexible printed wiring board 20 will fold at the folding part 55 of the first flexible printed wiring board 50, resulting in being able to suppress stress exerted on the connecting part formed by the solder.

In other words, it is possible to suppress stress from being exerted on the connection part formed by the solder, while positioning the second flexible printed wiring board 20 at a prescribed location with respect to the first flexible printed wiring board 50. As a result, the durability of the connection part can be improved, while stably connecting the first flexible printed wiring board 50 and the second flexible printed wiring board 20.

In the present embodiment, the first opening 52 and second opening 53 are parallel to each other and have the same width, but without being limited thereto, the extending direction of the first opening 52 and the extending direction of the second opening 53 may intersect and the first opening 52 and second opening 53 may have mutually different widths.

A connecting structure for flexible printed wiring boards according to Embodiment 3 of the present invention will be explained below. In the connecting structure for flexible printed wiring boards according to Embodiment 3, only a location of a first opening and a second flexible printed circuit board differs from the connecting structure for flexible printed wiring boards in Embodiment 1, and thus, explanations for other elements will not be repeated.

### Embodiment 3

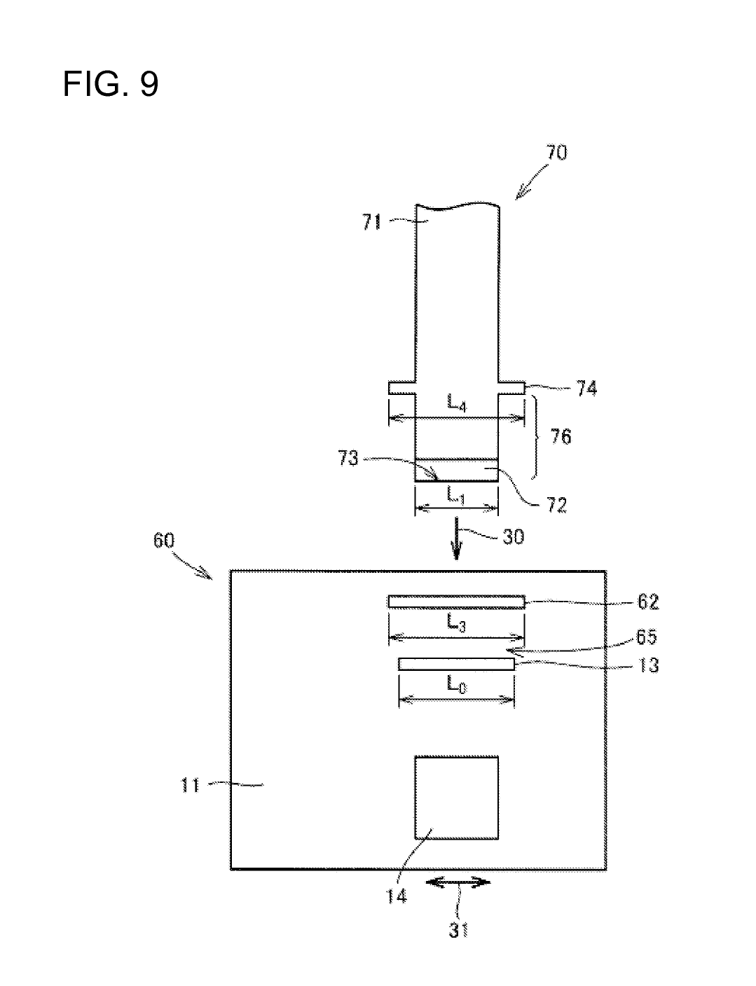

FIG. 9 is a partial plan view showing a first flexible printed wiring board and a second flexible printed wiring board, both of which form a connecting structure for flexible printed wiring boards according to Embodiment 3 of the present invention.

As shown in FIG. 9, in the connecting structure for flexible printed wiring boards in Embodiment 3 of the present invention, a first wiring line 14 of a first flexible printed wiring board 60 and a second wiring line 72 of a second flexible printed wiring board 70 will be electrically connected.

The flexible printed wiring board 60 has the first wiring line 14 on one main surface, and includes a first opening 62 and second opening 13 that extend at a prescribed distance from each other. A portion of the second flexible printed wiring board 70 is inserted into the first opening 62 and second opening 13.

In the first flexible printed wiring board 60, the first wiring line 14 is formed on the one main surface of a base material 11. In FIG. 9, only a soldered portion of the first wiring line 14 is shown.

The rectangular first opening 62 and second opening 13, which extend in the width direction, are formed substantially parallel to the base material 11. The width in the width direction of the first opening 62 is L₃. The width in the width direction of the second opening 13 is L₀. L₃>L₀ and the first opening 62 has a greater width than the second opening 13 in the width direction. The gap between the first opening 62 and second opening 13 in the insertion direction acts as a folding part 65.

The second flexible printed wiring board 70 has the second wiring line 72 on one main surface on a narrow-width section 76, which is located at the tip part in the insertion direction and which has a uniform width that is narrower than the width L₀ of the second opening 13 in the width direction. The second flexible printed wiring board 70 contains a positioning section 74 that connects to a narrow-width section 76 and that has a width L₄ greater than the width L₀ of the second opening 13 in the width direction.

The positioning section 74 has the width L₄, which is less than the width L₃ of the first opening 62 in the width direction and greater than the width L₀ of the second opening 13 in the width direction. The positioning section 74 juts out in the width direction on the edges of the narrow-width section 76.

In the second flexible printed wiring board 70, the second wiring line 72 is formed on the one main surface of a base material 71. In FIG. 9, only a soldered portion of the second wiring line 72 is shown. The soldered portion of the second wiring line 72 is formed in the vicinity of a tip 73 of the second flexible printed wiring board 70.

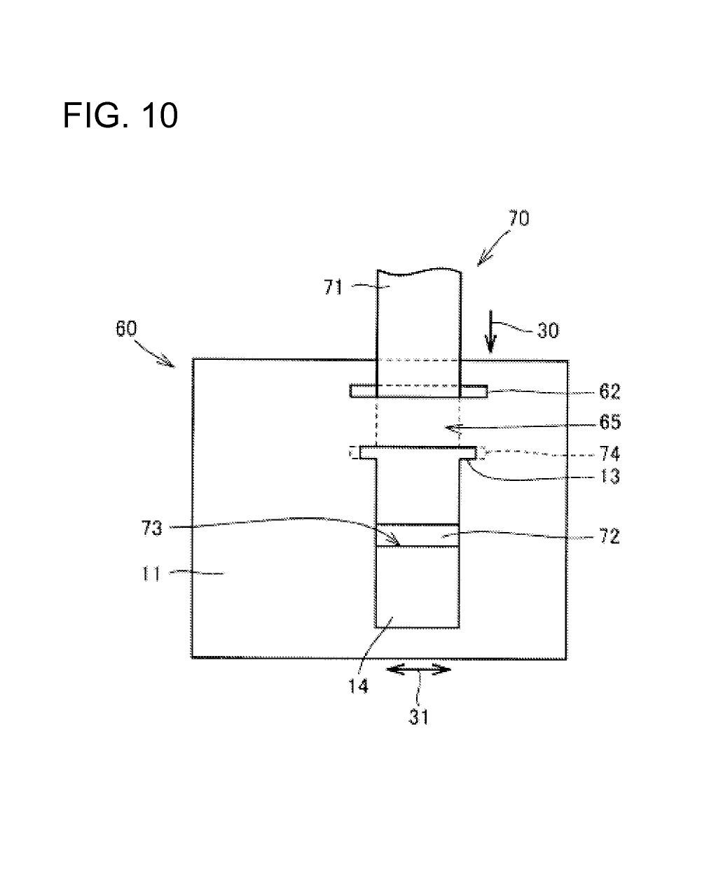

FIG. 10 is a plan view showing a state in which the first flexible printed wiring board and second flexible printed wiring board have been locked together in the present embodiment.

As shown in FIG. 10, when the narrow-width section 76 of the second flexible printed wiring board 70 is inserted into the first opening 62 and second opening 13 of the first flexible printed wiring board 60, the second flexible printed wiring board 70 is positioned on the other main surface of the first flexible printed wiring board 60 between the first opening 62 and second opening 13. The second flexible printed wiring board 70 is also positioned on the one main surface of the first flexible printed wiring board 60 opposite to the side of the first opening 62 near the second opening 13 and opposite to the side of the second opening 13 near the first opening 62.

In other words, the second flexible printed wiring board 70 is folded at the folding part 65 located between the first opening 62 and second opening 13.

The width L₄ of the positioning section 74 of the second flexible printed wiring board 70 is greater than the width L₀ of the second opening 13, and thus the second opening 13 and positioning section 74 are joined together when the narrow-width section 76 goes through the second opening 13.

In this state, the soldering portion of the first wiring line 14 of the first flexible printed wiring board 60 and the soldering portion of the second wiring line 72 of the second flexible printed wiring board 70 are positioned adjacent to each other. As such, the second flexible printed wiring board 70 is positioned at a prescribed location with respect to the first flexible printed wiring board 60.

Solder is applied so as to cover both the soldering portion of the first wiring line 14 of the first flexible printed wiring board 60 and the soldering portion of the second wiring line 72 of the second flexible printed wiring board 70. The solder electrically connects the first flexible printed wiring board 60 and the second flexible printed wiring board 70.

In other words, the first wiring line 14 and the second wiring line 72 are connected when the second opening 13 of the first flexible printed wiring board 60 and the positioning section 74 of the second flexible printed wiring board 70 are joined in order to lock the first flexible printed wiring board 60 and the second flexible printed wiring board 70 together.

As described above, electrically connecting the first flexible printed wiring board 60 and the second flexible printed wiring board 70 together joins the second opening 13 of the first flexible printed wiring board 60 and the positioning section 74 of the second flexible printed wiring board 70, and thus, it is possible to suppress stress being exerted on the connecting part formed by the solder when stress is applied in the width direction shown by an arrow 31 to the base material 71 of the second flexible printed wiring board 70.

When stress is applied to the base material 71 of the second flexible printed wiring board 70 in a direction opposite to the insertion direction, the second flexible printed wiring board 70 will fold at the folding part 65 of the first flexible printed wiring board 60, resulting in being able to suppress stress exerted on the connecting part formed by the solder.

In other words, it is possible to suppress stress from being exerted on the connection part formed by the solder, while positioning the second flexible printed wiring board 70 at a prescribed location with respect to the first flexible printed wiring board 60. As a result, the durability of the connection part can be improved, while stably connecting the first flexible printed wiring board 60 and the second flexible printed wiring board 70.

In the present embodiment, the first opening 62 and second opening 13 are parallel to each other, but without being limited thereto, the extending direction of the first opening 62 and the extending direction of the second opening 13 may intersect.

The embodiments disclosed herein are examples in every respect and are not limiting. The scope of the present invention is defined by the claims, and all modifications with the same meaning as the claims and within the scope defined thereby are included.

### DESCRIPTION OF REFERENCE CHARACTERS

10, 50, 60 first flexible printed wiring board

11, 21, 71 base material

12, 52, 62 first opening

13, 53 second opening

14 first wiring line

15, 55, 65 folding part

20, 70 second flexible printed wiring board

22, 72 second wiring line

23, 73 tip

24, 74 positioning section

25 tip corner section

26, 76 narrow-width section

40 solder

1. A connecting structure for flexible printed wiring boards, configured such that a first wiring line on a first flexible printed wiring board electrically connects to a second wiring line on a second flexible printed wiring board,
wherein the first flexible printed wiring board comprises: the first wiring line on one main surface thereof; and an elongated first opening and an elongated second opening that are positioned at a prescribed distance from each other, the second flexible printed wiring board having a portion to be inserted into the first opening and the second opening,
wherein the second flexible printed wiring board comprises: the second wiring line on one main surface of a narrow-width section, the narrow-width section being located at a tip area in an insertion direction and having a smaller width than the first opening and the second opening in a width direction, the width direction being perpendicular to the insertion direction towards the first flexible printed wiring board; and a positioning section that is connected to the narrow-width section and that has a greater width than either the first opening or the second opening in the width direction,
wherein the second flexible printed wiring board is on a side of the other main surface of the first flexible printed wiring board between the first opening and the second opening when the narrow-width section is inserted into the first opening and the second opening, and, the second flexible printed wiring board is on a side of the one main surface of the first flexible printed wiring board in regions other than between the first opening and second opening, and
wherein the first wiring line and the second wiring line are connected when the first opening or the second opening is coupled to the positioning section to lock the first flexible printed wiring board and the second flexible printed wiring board together.

2. The connecting structure for flexible printed wiring boards according to claim 1,
wherein the insertion direction and the extending direction of the first opening intersect each other at an acute angle.

3. The connecting structure for flexible printed wiring boards according to claim 1,
wherein the narrow-width section of the second flexible printed wiring board has a tapered shape that becomes wider the further the narrow-width section is from the tip area.

4. The connecting structure for flexible printed wiring boards according to claim 1,
wherein the first opening is wider than the second opening in the width direction,
wherein the narrow-width section has a uniform width that is less than the width of the second opening, and
wherein the positioning part is narrower than the first opening in the width direction and wider than the second opening in the width direction.
